(19) United States
(12) Patent Application Publication
(10) Pub. No.: US 2002/0194016 A1
(43) Pub. Date: Dec. 19, 2002

(54) Safe driving support system

(75) Inventors: Nobuyuki Moribe, Fukuoka-shi (JP); Masato Miyagawa, Kawasaki-shi (JP); Yasuhiro Takahashi, Tokyo (JP); Noboru Sugisawa, Tokyo (JP); Masasuke Ishibashi, Tokyo (JP)

Correspondence Address: STAAS & HALSEY LLP, 700 11TH STREET, NW, SUITE 500, WASHINGTON, DC, 20001, US

(73) Assignee: FUJITSU LIMITED, Kawasaki (JP)

(21) Appl. No.: 10/166,265

(22) Filed: Jun. 11, 2002

(30) Foreign Application Priority Data
Jun. 13, 2001 (JP) 2001-178478

(51) Int. Cl. G06F 17/60

(52) U.S. Cl. 705/1

(57) ABSTRACT

A driving support system is provided for guiding a vehicle safely to the desired destination. To this end, use is made of a database of the past traffic accidents owned by an insurance company or public institution. Based on the comparison between the GPS data about the current position of the vehicle and the site data of the past accidents recorded in the database, the driver can be notified, by a warning beep or warning message on the monitor of the navigation system, that his or her vehicle is approaching the site of the past accident on the route. In this manner, though a past accident is now invisible, the driver can be careful in passing by the site where the accident occurred.

### BACKGROUND OF THE INVENTION

1. Field of the Invention

The present invention relates to a safe driving support system advantageously used for guiding a vehicle safely to the desired destination.

2. Description of the Related Art

As is known, a car navigation system can display the vehicle's current position on a road map by utilizing the global positioning system (GPS). An advanced example of car-related system utilizing such a current position display technique is the vehicle information communication system (VICS). In accordance with the VICS, a properly designed navigation unit can provide the driver with various kinds of traffic information, such as information about road regulation and traffic congestion, that is useful for the driver to reach the desired destination without getting lost even in an unknown area.

The conventional VICS, however, does not provide the driver with information of an accident that occurred in the past. Thus, the driver using a conventional navigation system may utterly fail to realize the danger that he or she is now heading toward a site where the same kind of traffic accidents have been caused repeatedly by many drivers. As a result, the driver, being unconscious of the ominous site, may plunge into the accident site without reducing the speed of the vehicle.

### SUMMARY OF THE INVENTION

The present invention has been proposed under the circumstances described above. It is, therefore, an object of the present invention to provide a safe driving support system which enables the driver to notice the above-described invisible danger that he or she may encounter in driving a car.

According to a first aspect of the present invention, there is provided a safe driving support device that includes: a location collector that collects current location data of the current location of a vehicle; a database that stores accident information including site data of an accident and situation data relating to the accident; a filtering data storage that stores filtering data relating to the vehicle and/or the driver of the vehicle; an information extractor that extracts the accident information from the database; and a support processor that contributes to safe driving of the vehicle based on the extracted accident information.

In this embodiment, the information extractor determines, based on comparison between the current location data collected by the location collector and the site data of the accident information stored in the database, whether the accident occurred in a predetermined range of the current location of the vehicle. When the accident is found to have occurred in the predetermined range, the information extractor further determines, based on comparison between the situation data of the accident and the filtering data, whether the accident information is relevant to the filtering data. When the accident information is found relevant to the filtering data, the information extractor extracts the accident information from the database.

According to a second aspect of the present invention, there is provided a safe driving support device that is mounted on a vehicle and capable of making interactive data communications with a safe driving support center. The device may include: a location collector that collects current location data of a current location of a vehicle; a filtering data storage that stores filtering data relating to the vehicle and/or a driver of the vehicle; a transmitter that transmits the current location data to the support center; a receiver that receives accident information supplied from the support center in response to the transmitted current location data; an information extractor that extracts a piece of accident data relevant to the filtering data, the extraction being performed from the accident information by comparison between the received accident information and the filtering data; and a support processor that contributes to safe driving of the vehicle based on the extracted accident data. The above-mentioned piece of accident data includes site data of an accident and situation data of the accident.

According to a third aspect of the present invention, there is provided a safe driving support device that is mounted on a vehicle and capable of making interactive data communications with a safe driving support center. The device may include: a location collector that collects current location data of the current location of a vehicle; a filtering data generator that generates filtering data relating to the vehicle and/or a driver of the vehicle; a transmitter that transmits the current location data and the generated filtering data to the support center; a receiver that receives safe driving support information supplied from the support center in response to the transmission to the support center; and a support processor that contributes to safe driving of the vehicle based on the received safe driving support information. Again, the safe driving support information may include site data of an accident and situation data of the accident.

The support processor may produces an audio or visual warning for the driver of the vehicle based on the accident information. Or, the support processor may control the driving state of the vehicle based on the accident information. For instance, the support processor may automatically reduce the speed of the vehicle when the vehicle is passing by the site of a past accident.

Preferably, the support processor may be provided with a navigating function to show a route for guiding the vehicle to the desired destination. The route may be determined, based on the accident information, so that the route avoids any accident sites.

According to a fourth aspect of the present invention, there is provided a safe driving support center system arranged to make interactive data communications with a safe driving support device mounted on a vehicle. The system may include: a database storing accident information that includes site data of accidents and situation data relating to the accidents; a receiver that receives current location data of the vehicle, the location data being transmitted from the safe driving support device; an information extractor that extracts accident information from the database by comparison between the received current location data of the vehicle and the site data of the accidents stored in the database, the extracted accident information being relating to an accident that occurred in a predetermined range of a current location of the vehicle; and a transmitter that transmits the extracted accident information to the safe driving support device.

According to a fifth aspect of the present invention, there is provided a safe driving support center system arranged to make interactive data communications with a safe driving support device mounted on a vehicle. The system may include; a database storing accident information that includes site data of accidents and situation data relating to the accidents; a receiver that receives current location data of the vehicle transmitted from the safe driving support device, the receiver also receiving filtering data relating to the vehicle or a driver of the vehicle; an information extractor that extracts accident information from the database; and a transmitter that transmits the extracted accident information to the safe driving support device. The extraction of the accident information may be performed by searching for the situation data of accidents that occurred in a predetermined range of a current location of the vehicle, and then by determining whether the searched situation data and the filtering data are relevant to each other.

According to a sixth aspect of the present invention, there is provided a computer program for controlling a safe driving support device mounted on a vehicle. The program may execute the steps of: collecting current location data of the vehicle; accessing a database that stores accident information that includes site data of accidents situation data relating to the accidents; accessing a filtering data storage that stores filtering data relating to the vehicle or a driver of the vehicle; making a first comparison between the collected current location data of the vehicle and the site data stored in the database; extracting, from the database, site data of an accident that occurred in a predetermined range of a current location of the vehicle; making a second comparison between accident information corresponding to the extracted site data and the filtering data; extracting accident information from the database, the extracted accident information being found to satisfy a predetermined condition at the second comparison step; and supporting safe driving of the vehicle based on the extracted accident information.

According to a seventh aspect of the present invention, there is provided a computer program for controlling a safe driving support device that is mounted on a vehicle and arranged to make interactive data communications with a safe driving support center. The program may execute the steps of: collecting current location data of the vehicle; accessing a filtering data storage that stores filtering data relating to the vehicle and a driver of the vehicle; transmitting the collected current location data of the vehicle to the safe driving support center; receiving accident information supplied from the support center in response to the data transmission to the support center; making a comparison between the received accident information and the filtering data; extracting accident information that satisfies a predetermined condition; and supporting safe driving of the vehicle based on the extracted accident information.

According to an eighth aspect of the present invention, there is provided a computer program for controlling a safe driving support device that is mounted on a vehicle and arranged to make interactive data communications with a safe driving support center. The program may execute the steps of: collecting current location data of the vehicle; generating filtering data relating to the vehicle or a driver of the vehicle; transmitting the collected current location data of the vehicle and the generated filtering data to the safe driving support center; receiving accident information supplied from the support center in response to the data transmission to the support center, the received accident information including site data of an accident and situation data relating to the accident; and supporting safe driving of the vehicle based on the received accident information.

According to a ninth aspect of the present invention, there is provided a computer program for controlling a safe driving support device that is mounted on a vehicle and arranged to make interactive data communications with a safe driving support center. The program may execute the steps of: accessing a database that stores accident information including site data of accidents and situation data relating to the accidents; receiving current location data of the vehicle transmitted from the safe driving support device; extracting accident information from the database by comparison between the received current location data and the site data stored in the database, the extracted accident information relating to an accident that occurred in a predetermined range of a current location of the vehicle; and transmitting the extracted accident information to the safe driving support device.

According to a tenth aspect of the present invention, there is provided a computer program for controlling a safe driving support device that is mounted on a vehicle and arranged to make interactive data communications with a safe driving support center. The program may execute the steps of: accessing a database that stores accident information including both site data of accidents and situation data that relates to the accidents and corresponds to the site data; receiving current location data of the vehicle transmitted from the safe driving support device; receiving filtering data relating to the vehicle or a driver of the vehicle; extracting site data from the database by comparison between the received current location data and the site data stored in the database, the extracted site data relating to an accident that occurred in a predetermined range of a current location of the vehicle; making a comparison between situation data corresponding to the extracted site data and the filtering data; extracting accident information from the database when a predetermined condition is satisfied; and transmitting the extracted accident information to the safe driving support device.

Other features and advantages of the present invention will become apparent from the detailed description given below with reference to the accompanying drawings.

### BRIEF DESCRIPTION OF THE DRAWINGS

FIG. 1 is a schematic diagram illustrating the basic concept of the present invention;

FIG. 2 shows the principal components of the navigation system and information center used for implementing the present invention;

FIG. 3 is a flow chart illustrating the route searching process performed by the navigation unit of the present invention;

FIG. 4 is a flow chart illustrating the vehicle controlling procedure performed by the navigation unit of the present invention; and

FIG. 5 is a flow chart showing another example of the vehicle controlling procedure performed by the navigation unit of the present invention.

### DETAILED DESCRIPTION OF THE PREFERRED EMBODIMENTS

Preferred embodiments of the present invention will be described below with reference to the accompanying drawings.

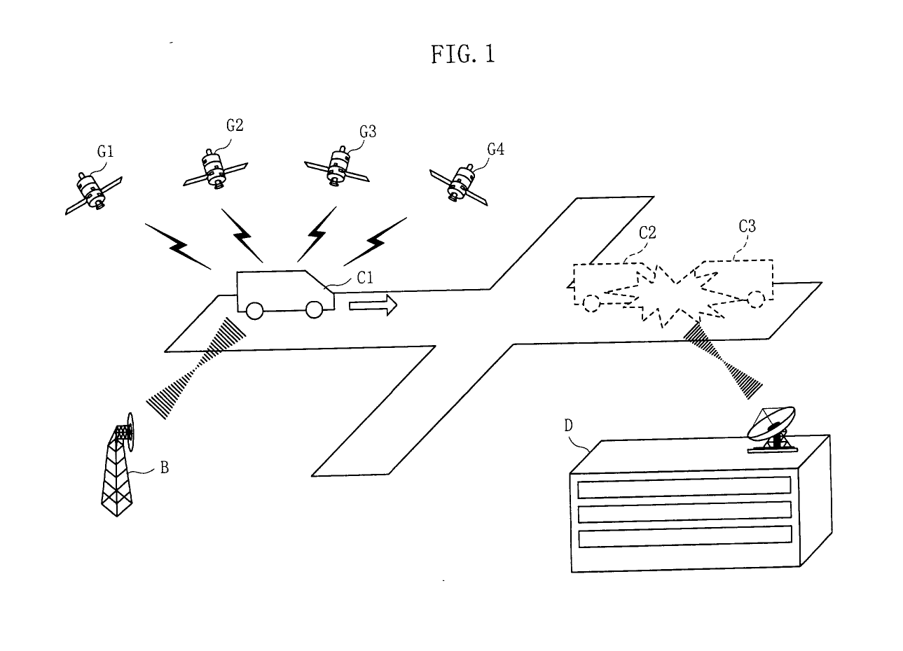

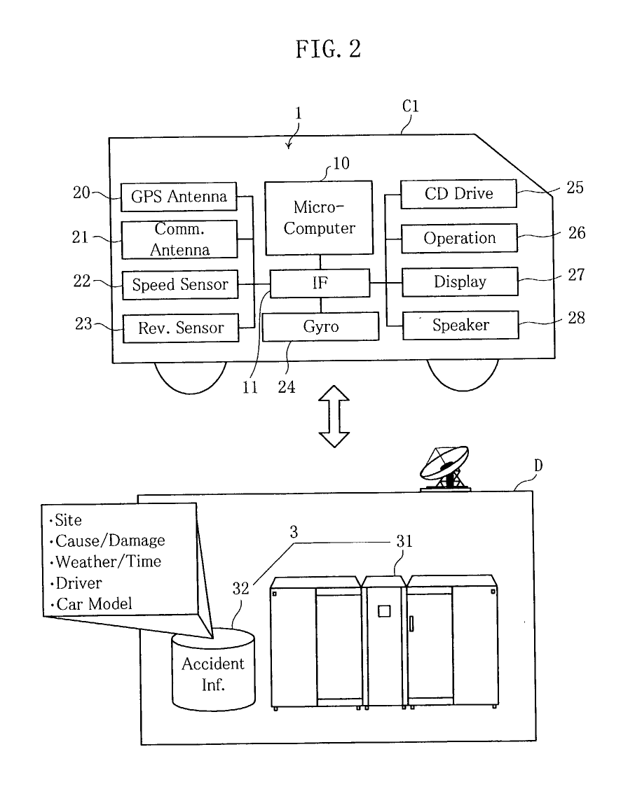

FIG. 1 illustrates the basic concept of a safe driving support system of the present invention. In accordance with this system, a vehicle C1 is provided with a navigation unit, or safe drive supporting unit (reference numeral 1 in FIG. 2). This navigation unit receives GPS (Global Positioning System) signals transmitted from a plurality of GPS satellites (in the figure, four satellites G1˜G4 are shown). Based on these GPS signals, the current position of the vehicle C1 can be determined. In the illustrated embodiment, the navigation unit is designed to exchange data with an information center D (an insurance company or public institution for example) via a ground beacon B. The data exchange may be performed directly (i.e., without the-beacon B) between the navigation unit and the information center D. The information center D has a database for storing information about traffic accidents that occurred in the past.

Referring to FIG. 2, the navigation unit 1 includes a microcomputer 10, an interface 11, a GPS antenna 20, a communication antenna 21, a speed sensor 22, a rotation sensor 23, a rate gyroscope (angular velocity sensor) 24, a CD drive 25, an operating section 26, a monitor 27 and a speaker 28. The microcomputer 10 is connected via the interface 11 to the antennas 20˜21, the sensors 22˜23, the gyroscope 24, the CD drive 25, the operating section 26, the monitor 27 and the speaker 28.

The information center D is provided with a databank machine, or safe drive supporting center system 3 for analyzing the collected data of the past traffic accidents. As shown in FIG. 2, the databank machine includes a high-speed data processing computer 31 and a hard disk storage 32 for storing a massive amount of the accident data.

The microcomputer 10 of the navigation unit 1 controls the overall operations of the navigation unit 1. The microcomputer 10 may incorporate a semiconductor memory for storing traffic accident information including the driver's name, the number or code of the vehicle, etc. The interface 11 controls the input and output of the microcomputer 10. The GPS antenna 20 receives the GPS signal (microwaves). The communication antenna 21 is provided for sending data to or receiving data from the ground beacon B. This data transmitted between the antenna 21 and the beacon B may be optical data or radio wave data. Further, the antenna 21 may be designed for performing direct data communication with the information center D by FM multi-broadcasting.

The speed sensor 22 detects the traveling speed of the running vehicle C1, and the detected value is sent to the microcomputer 10. The rotation sensor 23 detects the number of revolutions of the engine of the vehicle C1, and the detected value is sent to the microcomputer 10. The gyroscope 24 detects the acceleration of the rotation of the vehicle C1, and the detected value is sent to the microcomputer 10.

The CD drive 25 is provided for reading data from a CD-ROM which may store road map data. The retrieved data is sent to the microcomputer 10. The operating section 26 is provided with keys to be operated by the user. The input data is sent to the microcomputer 10. The monitor 27 is controlled by the microcomputer 10 to display the required road map and/or guidance. The speaker 28 is controlled by the microcomputer 10 to provide audio information.

The databank machine 3 includes a database and a main frame accessible to the database. The computer 31 of the databank machine 3 collects (automatically or manually) and analyzes traffic accident information. Under control of the computer 31, the traffic accident information to be sent to the navigation unit 1 is added to the database stored in the hard disk storage 32. This information is sent to the navigation unit 1 via the ground beacon B (or without being relayed by the beacon B). In the present embodiment, the traffic accident information may regard the accident site, the cause of the accident (inattentive driving, excessive speed, sharp turn, etc.), the type of the accident (physical injury, property destruction, etc.), the time of the accident, the weather, the name of the driver (who caused the accident), the type of the vehicle, etc. The traffic accident information of the present invention may regard other kinds of data, but needs to include at least the parameters to identify the accident site for the GPS data. These parameters may be the latitude and longitude of the site, and the altitude where appropriate.

The data collecting of the accident may proceed in the following manner.

Referring to FIG. 1, when two cars C2 and C3 come into collision, as shown in broken lines, the navigation unit 1 mounted on each car (or only one of them) sends various kinds of information (referred to as “accident data”below) to the information center D. In the present embodiment, the accident data may regard the accident site (GPS data), prescribed physical values (detected by the sensors 22, 23 and the gyroscope 24), the operating condition of the wiper switch, the ID codes of the driver and the car, etc. The transmitted accident data is automatically collected and registered by the databank machine 3 of the information center D. For certain information that cannot be collected automatically (the type of the accident, for example), a manual data collecting procedure may need to be performed in addition to the automated data collection. In this case, the person responsible for the accident may make a call to the information center D to report the circumstances of the accident, and an operator of the center D registers the supplied accident data.

The accident data registered in the databank machine 3 is transmitted to the respective vehicles equipped with the navigation units 1, so that the traffic accident information stored in each unit is updated. This updating data may be transmitted regularly or occasionally without being requested from the navigation unit 1. Alternatively, the data transmission may be initiated upon request from the unit 1.

The traffic data registered in the navigation unit 1 is utilized for the vehicle C1. For instance, based on the registered data, it is possible to display the location of an accident site(or sites) within a prescribed distance from the current position of the vehicle C1 which may be idling or traveling. According to the present invention, the traffic accident information may be sieved or filtered by certain parameters such as the traveling conditions of the vehicle C1 and the character of the driver, so that only the particular pieces of information relevant to the driver or the vehicle will be displayed. For instance, when the vehicle is exceeding the speed limit, the display indicates the locations of the nearby accident scenes where accidents had occurred due to the excessive speed of the vehicles.

As in the conventional unit, the navigation unit 1 of the present invention selects and displays a route which the driver should follow to go from a specified point (the driver's residence for example) to the destination. This selection may be made among several possible routes in accordance with the above-mentioned filtering process for the traffic accident information. The selected route is the one that can avoid the accident sites of the past. Thus, following this particular route, the driver can travel safely from the start to the desired destination.

If there is no other choice but to follow a route that passes through the accident site, the microcomputer 10 monitors how close the vehicle C1 has come to the ominous site. When the computer 10 determines that the vehicle C1 is in a prescribed vicinity of the site, a warning message may appear on the display 27 and/or a warning sound may be produced from the speaker 28. In this manner, the driver can recognize that the vehicle C1 is approaching the past accident site. Accordingly, it is possible for the driver to reduce the speed deliberately, thereby shifting to the safe driving mode.

Preferably, the computer 10 may automatically control the driving behavior of the vehicle C1 when the vehicle C1 has come near the accident site. Specifically, the computer 10 may issue instructions to the engine and/or the break in accordance with the accident information obtained through the filtering process. As a result, the vehicle C1 may automatically slow down when it is approaching the accident site.

The above-mentioned warning function and the automated speed-reducing function may be turned on or off selectively by the user.

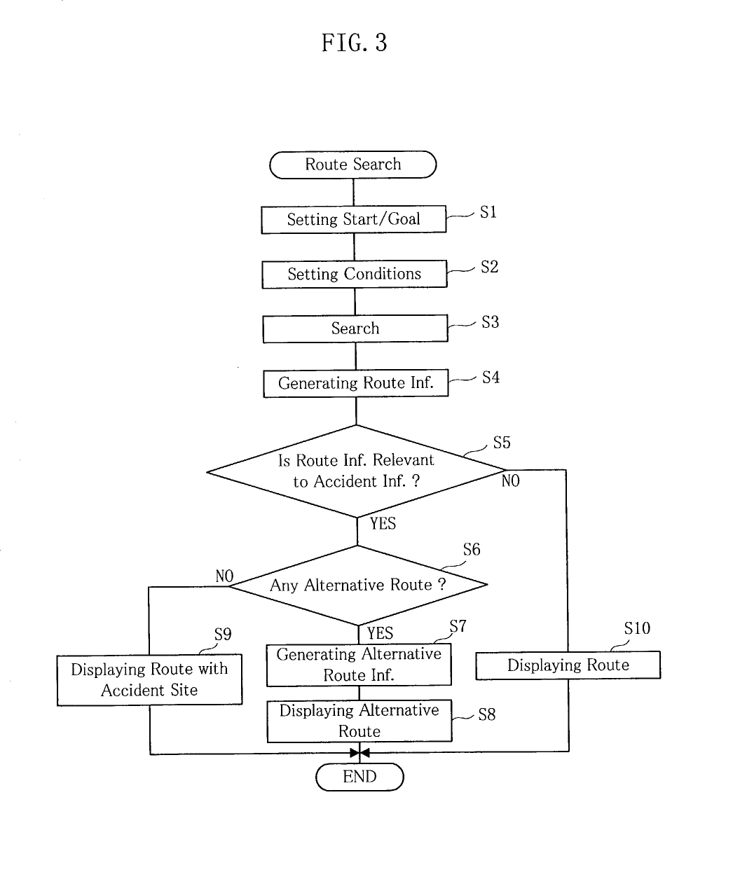

Referring now to FIG. 3, the flow chart shows the route-finding task performed by the navigation unit 1. When the information about the start and the destination is entered by the driver, it is converted into GPS-enabled latitude data and longitude data by the computer 10 of the navigation unit 1 (S1). The data input may readily be performed by bringing the cursor to the start and the destination on the on-screen road map, or by typing in the addresses of the start and the destination, or by typing in the telephone numbers of the start and the destination.

After the data of the starting point and the destination is inputted, other necessary data (filtering data) such as the time of departure, the time of arrival, the type of the car, the driver's ID, the type of the cargo, etc. is entered and registered by the computer 10 (S2). All the pieces of the filtering data or only part of them may be pre-registered.

Based on the inputted data, the computer 10 will find optimum route among the road map data (S3).

When the optimum route has been found, the computer 10 produces “route information” based on the optimum route (S4). The route information is made up of GPS-enabled route point data (latitude and longitude data) that represents a predetermined number of points (including the start and the destination) of the optimum route.

Meanwhile, the computer 10 reads out the traffic accident information registered in the storage. Then, the computer 10 determines whether the route information corresponds to any piece of the traffic accident information (S5). Specifically, the computer 10 checks if any one of the points representing the selected route coincides with an accident site or is within a prescribed range of an accident site.

When route point data is found to correspond to the traffic accident site (S5:YES), the computer 10 searches for a different route along which the traffic accident site is avoided (S6).

When such an alternative route is found (S6:YES), the computer 10 regards this new route as the selected route, and prepares the latitude and longitude data for this selected route (S6).

Thereafter, the computer 10 displays the road map with the selected route depicted therein (S8). Thus, the route searching procedure comes to an end.

When there is no alternative route that avoids the traffic accident site (S6:NO), the computer 10 adopts the originally prepared route information (S4), and displays the route with the indication of the traffic accident site (S9). Thus, the route searching procedure comes to an end.

When no route points coincide with the traffic accident site (S5:NO), the computer 10 adopts the route information prepared at S4, and displays the road map with the selected route depicted therein (S10).

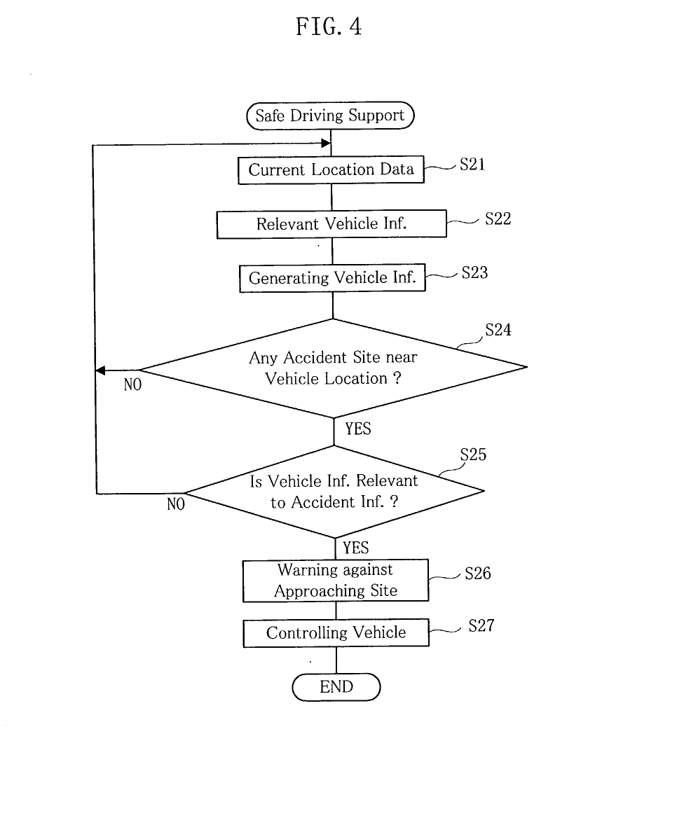

The flow chart of FIG. 4 illustrates the vehicle operation control performed by the navigation unit 1. The computer 10 calculates the current position of the vehicle based on the GPS signals from the GPS satellites G1, G2 and so on (S21). The GPS signals cannot be properly transmitted while the vehicle C1 is in a tunnel for example. However, with an automated navigation system including the speed sensor 22 and the gyroscope 24, the position of the vehicle can always be known. As known in the art, at least three satellites are needed to provide both latitude data and longitude data, while at least four are needed to provide altitude data in addition to the latitude and longitude data.

The microcomputer 10 also collects other kinds of filtering information on the vehicle's conditions than the current position (S22). For instance, the computer 10 collects the vehicle's speed detected by the speed sensor 22, the engine's revolution detected by the rotation sensor 23, the rotational acceleration detected by the gyroscope 24, the time and conditions of the driver. By detecting the vehicle's speed, the engine revolution and the rotational acceleration, it is possible to know the behavior of the vehicle C1 (for instance, how sharply the car accelerates, makes a turn, and so forth).

Based on the collected data, the computer 10 prepares vehicle information (S23). Such vehicle information is prepared at regular intervals through the repetition of the routine shown in FIG. 4.

The computer 10 compares the vehicle information with the registered traffic accident information. By this, the computer 10 determines whether there is any accident site of the past within a prescribed distance of the current position of the vehicle C1 (S24).

When the answer is “YES” (S24), the microcomputer 10 determines whether there is any piece of the vehicle information that is relevant to the accident information (S25). Specifically, computer 10 determines whether the vehicle's current speed, engine revolution, rotational acceleration, etc., or the current weather, time and so forth match with the conditions of the past accident.

When at least one relevant piece of the vehicle information is found (S25:YES), the computer 10 displays a warning message on the monitor 27 and/or makes a warning sound from the speaker 28, to inform the driver that the accident site is approaching (S26).

Further, the computer 10 sends control instructions to the engine system and/or braking system so that the vehicle C1 will drive safely (S27). Thereafter, the computer 10 ends the routine and goes back to Step 21.

When the answer is “NO” at Step 25 (that is, when the vehicle C1 is safely driving), the computer 10 goes back to Step 21. At this stage, however, since a past accident site is approaching after all, a warning message or sound may be produced so that the driver will continue the safe driving.

When the answer is “NO” at Step 24 (that is, there is no accident site nearby), the computer 10 goes back to Step 21.

According to the above embodiment, as noted above, the traffic accident information from the information center D is incorporated into the storage of the navigation unit 1, and based on this information, a warning message or sound together with the road map display, is produced. Further, the vehicle is automatically driven safely under the control of the computer 10. In this manner, the traffic accident database of an insurance company or public office is advantageously utilized for enabling the drive of a vehicle to involve in a traffic accident.

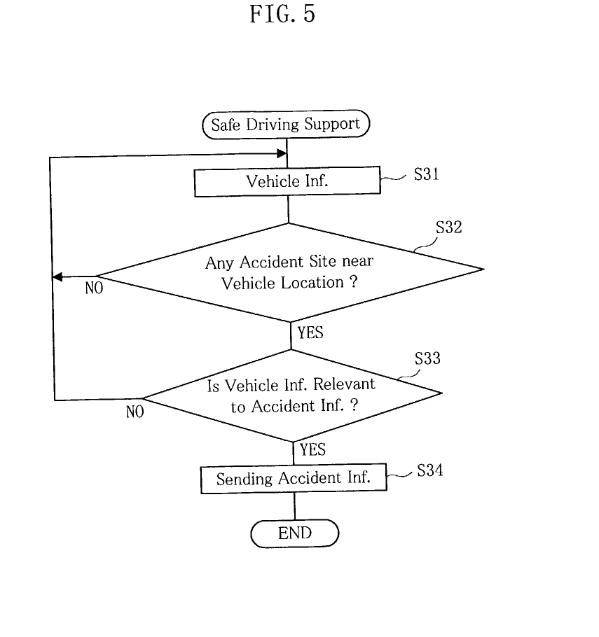

Reference is now made to FIG. 5 which is a flow chart illustrating a second embodiment of the present invention. In this embodiment, the navigation unit 1 sends the vehicle information (i.e., the vehicle's current position, driving speed, etc.) to the databank machine 3 (see FIG. 2), and then useful information about a past traffic accident will be sent back to the navigation unit 1 from the databank machine 3. A more detailed description will be given below.

As shown in FIG. 5, the databank machine 3 receives the vehicle information transmitted from the navigation unit 1 of the vehicle C1 at regular intervals for example (S31).

Then, the databank machine 3 compares the vehicle information with the traffic accident information registered in the hard disk storage 32, to see whether any traffic accident has ever occurred within a prescribed distance from the current position of the vehicle C1 (S32).

When the answer is “YES” at Step 32, the databank machine 3 checks whether the vehicle information contains an item relevant to the traffic accident information (S33) as in Step 25 of FIG. 4.

When there is a match between the vehicle information and the traffic accident information (S33:YES), the databank machine 3 transmits the relevant traffic accident data to the navigation unit 1 of the vehicle C1 (S34), and then ends the process. Upon receiving the data from the databank machine 3, a warning message and/or warning sound against the approaching accident site will be produced on the monitor 27 or from the speaker 28 under the control of the navigation unit 1. Further, as in the previous embodiment, the engine system and/or braking system may be controlled to enable the vehicle C1 to travel safely.

When no match is found at Step 33 (S33:NO), the databank machine 3 goes back to Step 31. According to this embodiment, as in the first embodiment, the traffic accident information may be transmitted to the navigation unit 1 before the databank machine 3 returns to Step 31.

At Step 32, when no traffic accident has been reported in the prescribed vicinity of the vehicle C1 (S32:NO), the databank machine 3 goes back to Step 31.

The present invention is not limited to the above-described embodiments. For instance, use may be made of recoding mediums such as CD-ROMs for supplying traffic accident information to the navigation unit 1. In this case, the databank machine 3 may be dispensed with.

Further, in performing radio data transmission between the navigation unit 1 and the databank machine 3, the navigation unit 1 may send only the GPS data (current position data) to the databank machine 3. Analyzing this position data, the databank machine 3 transmits the traffic accident information about nearby accident sites to the navigation unit 1. Then, this traffic accident information is subjected to the filtering process in search of a piece of accident data relevant to the vehicle C1.

The navigation unit 1 may not necessarily be a GPS-compatible type. For instance, the unit 1 may be a laptop computer with a monitor to display road maps (or merely display the latitude and longitude data, but no maps). The laptop may be not be placed in the vehicle C1. In this case, required traffic accident information may be printed on a paper sheet, and the driver may take this sheet (but not the laptop) into the vehicle.

The data transmission between the navigation unit 1 and the databank machine 3 may be made via a mobile communication network.

The present invention being thus described, it is obvious that the same may be varied in many ways. Such variations are not to be regarded as a departure from the spirit and scope of the present invention, and all such modifications as would be obvious to those skilled in the art are intended to be included within the scope of the following claims.

1. A safe driving support device comprising:
a location collector that collects current location data of a current location of a vehicle;
a database that stores accident information including site data of an accident and situation data relating to the accident;
a filtering data storage that stores filtering data relating to at least one of the vehicle and a driver of the vehicle;
an information extractor that extracts the accident information from the database; and
a support processor that contributes to safe driving of the vehicle based on the extracted accident information;
wherein the information extractor determines, based on comparison between the current location data collected by the location collector and the site data of the accident information stored in the database, whether the accident occurred in a predetermined range of the current location of the vehicle;
wherein when the accident occurred in the predetermined range, the information extractor further determines, based on comparison between the situation data of the accident and the filtering data, whether the accident information is relevant to the filtering data; and
wherein when the accident information is relevant to the filtering data, the information extractor extracts the accident information from the database.

2. A safe driving support device mounted on a vehicle and designed to make interactive data communications with a safe driving support center, the device comprising:
a location collector that collects current location data of a current location of a vehicle;
a filtering data storage that stores filtering data relating to at least one of the vehicle and a driver of the vehicle;
a transmitter that transmits the current location data to the support center;
a receiver that receives accident information supplied from the support center in response to the transmitted current location data;
an information extractor that extracts a piece of accident data relevant to the filtering data, the extraction being performed from the accident information by comparison between the received accident information and the filtering data; and
a support processor that contributes to safe driving of the vehicle based on the extracted accident data;
wherein said piece of accident data includes site data of an accident and situation data of the accident.

3. A safe driving support device mounted on a vehicle and designed to make interactive data communications with a safe driving support center, the device comprising:
a location collector that collects current location data of a current location of a vehicle;
a filtering data generator that generates filtering data relating to at least one of the vehicle and a driver of the vehicle;
a transmitter that transmits the current location data and the generated filtering data to the support center;
a receiver that receives safe driving support information supplied from the support center in response to the transmission to the support center; and
a support processor that contributes to safe driving of the vehicle based on the received safe driving support information;
wherein the safe driving support information includes site data of an accident and situation data of the accident.

4. The device according to claim 1, wherein the support processor produces an audio or visual warning for the driver of the vehicle based on the extracted accident information.

5. The device according to claim 1, wherein the support processor controls a driving state of the vehicle based on the extracted accident information.

6. The device according to claim 1, wherein the support processor is provided with a navigating function for showing a route guiding the vehicle to a desired destination, the route being determined, based on the accident information, so that the route avoids any accident sites.

7. The device according to claim 1, further comprising a filtering data generator that produces the filtering data based on a driving state of the vehicle.

8. A safe driving support center system arranged to make interactive data communications with a safe driving support device mounted on a vehicle, the system comprising;
a database storing accident information that includes site data of accidents and situation data relating to the accidents;
a receiver that receives current location data of the vehicle, the location data being transmitted from the safe driving support device;
an information extractor that extracts accident information from the database by comparison between the received current location data of the vehicle and the site data of the accidents stored in the database, the extracted accident information being relating to an accident that occurred in a predetermined range of a current location of the vehicle; and
a transmitter that transmits the extracted accident information to the safe driving support device.

9. A safe driving support center system arranged to make interactive data communications with a safe driving support device mounted on a vehicle, the system comprising;
a database storing accident information that includes site data of accidents and situation data relating to the accidents;
a receiver that receives current location data of the vehicle transmitted from the safe driving support device, the receiver also receiving filtering data relating to the vehicle or a driver of the vehicle;
an information extractor that extracts accident information from the database; and
a transmitter that transmits the extracted accident information to the safe driving support device;
wherein the extraction of the accident information is performed by searching for the situation data of accidents that occurred in a predetermined range of a current location of the vehicle, and by determining whether the searched situation data and the filtering data are relevant to each other.

10. A computer program for controlling a safe driving support device mounted on a vehicle, the program executing the steps of:
collecting current location data of the vehicle;
accessing a database that stores accident information that includes site data of accidents situation data relating to the accidents;
accessing a filtering data storage that stores filtering data relating to the vehicle or a driver of the vehicle;
making a first comparison between the collected current location data of the vehicle and the site data stored in the database;
extracting, from the database, site data of an accident that occurred in a predetermined range of a current location of the vehicle;
making a second comparison between accident information corresponding to the extracted site data and the filtering data;
extracting accident information from the database, the extracted accident information being found to satisfy a predetermined condition at the second comparison step; and
supporting safe driving of the vehicle based on the extracted accident information.

11. A computer program for controlling a safe driving support device that is mounted on a vehicle and arranged to make interactive data communications with a safe driving support center, the program executing the steps of:
collecting current location data of the vehicle;
accessing a filtering data storage that stores filtering data relating to the vehicle and a driver of the vehicle;
transmitting the collected current location data of the vehicle to the safe driving support center;
receiving accident information supplied from the support center in response to the data transmission to the support center;
making a comparison between the received accident information and the filtering data;
extracting accident information that satisfies a predetermined condition; and
supporting safe driving of the vehicle based on the extracted accident information.

12. A computer program for controlling a safe driving support device that is mounted on a vehicle and arranged to make interactive data communications with a safe driving support center, the program executing the steps of:
collecting current location data of the vehicle;
generating filtering data relating to the vehicle or a driver of the vehicle;
transmitting the collected current location data of the vehicle and the generated filtering data to the safe driving support center;
receiving accident information supplied from the support center in response to the data transmission to the support center, the received accident information including site data of an accident and situation data relating to the accident; and
supporting safe driving of the vehicle based on the received accident information.

13. A computer program for controlling a safe driving support device that is mounted on a vehicle and arranged to make interactive data communications with a safe driving support center, the program executing the steps of:
accessing a database that stores accident information including site data of accidents and situation data relating to the accidents;
receiving current location data of the vehicle transmitted from the safe driving support device;
extracting accident information from the database by comparison between the received current location data and the site data stored in the database, the extracted accident information relating to an accident that occurred in a predetermined range of a current location of the vehicle; and
transmitting the extracted accident information to the safe driving support device.

14. A computer program for controlling a safe driving support device that is mounted on a vehicle and arranged to make interactive data communications with a safe driving support center, the program executing the steps of:
accessing a database that stores accident information including both site data of accidents and situation data that relates to the accidents and corresponds to the site data;
receiving current location data of the vehicle transmitted from the safe driving support device;
receiving filtering data relating to the vehicle or a driver of the vehicle;
extracting site data from the database by comparison between the received current location data and the site data stored in the database, the extracted site data relating to an accident that occurred in a predetermined range of a current location of the vehicle;
making a comparison between situation data corresponding to the extracted site data and the filtering data;
extracting accident information from the database when a predetermined condition is satisfied; and
transmitting the extracted accident information to the safe driving support device.
